(19) United States
(12) Patent Application Publication
(10) Pub. No.: US 2015/0123498 A1
(43) Pub. Date: May 7, 2015

(54) LINEAR VIBRATOR AND PRODUCTION METHOD THEREFOR

(71) Applicants: Hyun-Ki YANG, Incheon (KR); Seong-Kwan Oh, Incheon (KR); Hyok-Sang Ahn, Incheon (KR); Se-Hee Park, Incheon (KR)

(72) Inventors: Hyun-Ki YANG, Incheon (KR); Seong-Kwan Oh, Incheon (KR); Hyok-Sang Ahn, Incheon (KR); Se-Hee Park, Incheon (KR)

(21) Appl. No.: 14/071,291

(22) Filed: Nov. 4, 2013

(51) Int. Cl. H02K 33/00; H02K 15/00

(52) U.S. Cl. CPC H02K 33/00; H02K 15/00
USPC 310/25; 29/596

(57) ABSTRACT

Disclosed herein is a vibration generator which is used to embody vibration for signal reception indication or a haptic function of wireless communication devices such as mobile phones. The vibration generator includes a casing which has a space therein, a stator which is provided in the casing and is provided with a coil along which current flows, a vibrator which is provided in the casing and is horizontally moved by electromagnetic force, an elastic body which is fixed at a first end thereof to the casing and fixed at a second end thereof to the vibrator, and a residual vibration reducer which is provided between the vibrator and the casing to absorb vibration of the vibrator. Therefore, after the vibration of the vibrator is stopped, the time it takes to stop movement of the vibrator can be markedly reduced.

### BACKGROUND OF THE INVENTION

1. Field of the Invention

The present invention relates generally to vibration generators for embodying vibration for signal reception indication or a haptic function of wireless communication devices such as mobile phones and, more particularly, to a vibration generator and a method of manufacturing the vibration generator which includes a casing having a space therein, a stator provided in the casing and having a coil along which current flows, a vibrator provided in the casing at a position facing the stator such that the vibrator can be horizontally moved by electromagnetic force, an elastic body fixed at a first end thereof to the casing and fixed at a second end thereof to the vibrator, and a residual vibration reducer provided between the vibrator and the casing to absorb vibration of the vibrator, whereby when the operation of the vibration generator is interrupted, the movement of the vibrator can be rapidly stopped; contact noise caused during the vibration of the vibrator can be reduced; and even after a long period of time has passed, the weight, the magnet and the elastic body can be prevented from being undesirably moved from their correct positions; and the performance of the vibration generator can be uniformly maintained even in conditions such as free-fall conditions.

2. Description of the Related Art

As examples of conventional vibration generators for embodying vibration for signal reception indication or a haptic function of wireless communication devices such as mobile phones, there are a vibration motor in which an eccentric or eccentric-mass type weight is installed in a brush DC motor, a BLDC (Brushless DC) vibration motor in which an eccentric type weight is installed in a rotor, a coin type vibration motor, a vertical vibration motor using resonance, etc. However, the conventional vibration generators are problematic in that they cannot satisfactorily realize certain requirements, such as long life span, reliability, thinness, and high vibration force that are required by devices such as mobile phones.

In an effort to overcome problems of vibration generators using brush DC motors, vertical vibration motors that vibrate upward and downward using resonance were proposed. Such vertical vibration motors can generate resonance vibration in a vibrator having an elastic body and a weight by causing oscillation in electromagnetic force using mutual interaction between the electromagnetic force and a magnetic field. However, the vertical vibration motors are mechanically problematic in that they have a vertically moving mechanism using an elastic body, and so they require a mechanical space in which the vibrators can move upward and downward, thus making it difficult to reduce the entire height of the vibration generator.

Furthermore, in the case of the conventional vibration generators installed in devices such as mobile phones which require vibration functions, the coupling state among the elements of the vibration generator is not reliable. Thus, for example, when a user drops a mobile phone due to careless, elements of the vibration generator may be removed from its original position, or the performance thereof may deteriorate. Such a problem of dislocation of the elements is mainly in regard to dislocation of a weight from an elastic body. Further, typical weights are made of tungsten which has a comparatively high specific gravity. Due to the characteristic that the tungsten material has a high melting point, coupling of the weight to the elastic body by melting cannot provide 100% reliability with regard to the coupling. In addition, a method using a chemical material to couple the weight to the elastic body also cannot ensure 100% reliability.

To solve the problems of the conventional vertical vibration generator, a horizontal vibration generator which horizontally vibrates was proposed in Korean Patent Application No. 2010-0090230, which was filed by the applicant of the present invention.

The conventional vibration generator introduced by the applicant of the present invention includes a casing, a vibrator which is installed in the casing and provided with a weight, and an elastic body which has a ‘U’ shape and encloses the weight. A first end of the elastic body is fixed to the weight, and a second end thereof is fixed to the casing. This vibration generator is configured such that horizontal vibration occurs using a resonant phenomenon induced by oscillation of electromagnetic force having the same frequency as the natural frequency of the elastic body. Therefore, this conventional vibration generator is advantageous in that the life span thereof is increased, and the vibration force thereof can be increased despite having a thin structure.

Recently, as the sizes of communication devices are increased, vibration generators that have strong vibration force are preferred. However, the vibration generators that have strong vibration force are problematic in that the time it takes to stop the vibration generator is increased as the vibration force thereof is increased. With regard to awareness obtained by alternation of motion and stop, as the time it takes to stop the vibration generator is increased in proportion to the time period for which the vibration generator has moved, it becomes difficult to realize the desired awareness function. The vibration generator introduced in the patent application of the present applicant does not have measures to cope with vibration response characteristic being deteriorated by an increase in the time it takes to stop the vibrator after the vibration of the vibration generator is stopped. Furthermore, there is no measure to cope with noise generated by contact between the vibrator and the casing or the other elements when the vibrator is vibrating.

### SUMMARY OF THE INVENTION

Accordingly, the present invention has been made keeping in mind the above problems occurring in the prior art, and an object of the present invention is to provide a vibration generator which includes a casing having a space therein, a stator provided in the casing and having a coil along which current flows, a vibrator provided in the casing at a position facing the stator such that the vibrator can be horizontally moved by electromagnetic force, and an elastic body fixed at a first end thereof to the casing and fixed at a second end thereof to the vibrator, wherein a residual vibration reducer is installed between the vibrator and the casing to absorb vibration of the vibrator in two stages, whereby when the operation of the vibration generator is interrupted, the movement of the vibrator can be rapidly stopped, and contact noise caused when the vibrator is vibrating can be reduced.

Another object of the present invention is to provide a vibration generator which includes a casing having a space therein, a stator provided in the casing and having a coil along which current flows, a vibrator provided in the casing at a position facing the stator such that the vibrator can be horizontally moved by electromagnetic force, and an elastic body fixed at a first end thereof to the casing and fixed at a second end thereof to the vibrator, wherein a coil stopper is provided to limit the movement of the coil and protect the coil from the vibrator, whereby when an external impact, e.g., free fall shock or the like, is applied to the vibration generator, the stator (coil) can be prevented from being undesirably moved or damaged due to movement displacement of the vibrator.

A further object of the present invention is to provide a vibration generator which includes a casing having a space therein, a stator provided in the casing and having a coil along which current flows, a vibrator provided in the casing at a position facing the stator such that the vibrator can be horizontally moved by electromagnetic force, and an elastic body fixed at a first end thereof to the casing and fixed at a second end thereof to the vibrator, wherein a spacer for spacing a portion of the first end of the elastic body, fixed to the casing, apart from an inner surface of the casing is provided so that the elastic body is prevented from making contact with the casing, thereby enhancing resonant frequency, and preventing performance deterioration.

Yet another object of the present invention is to provide a vibration generator which includes a casing having a space therein, a stator provided in the casing and having a coil along which current flows, a vibrator provided in the casing at a position facing the stator such that the vibrator can be horizontally moved by electromagnetic force, and an elastic body fixed at a first end thereof to the casing and fixed at a second end thereof to the vibrator, wherein the vibrator includes a weight having an inner space therein, and a first magnet, yoke plate and a second magnet that are installed in the inner space of the weight, whereby the size of the main magnet (first magnet) can be reduced, thus making it possible to reduce the cost required to provide the magnet.

Still another object of the present invention is to provide a vibration generator which includes a casing having a space therein, a stator provided in the casing and having a coil along which current flows, a vibrator provided in the casing at a position facing the stator such that the vibrator can be horizontally moved by electromagnetic force, and an elastic body fixed at a first end thereof to the casing and fixed at a second end thereof to the vibrator, wherein the second end of the elastic body is fixed to the weight of the vibrator, and the first end of the elastic body is bent by a predetermined length and a surface of a overlapping portion of the bent first end is fixed to an inner surface of the casing so that the elastic body has an approximate “S” shape, thus making it possible for the elastic body to be comparatively long and slim, thereby reducing spatial constraints, and providing high vibration.

Still another object of the present invention is to provide a method of manufacturing a vibration generator which can enhance the efficiency of the assembly process thanks to a simple assembly structure of the elements, and make the coupling between the elements more reliable, thus enhancing the reliability of products and reducing the production cost.

In order to accomplish the above object, the present invention provides a vibration generator, including: a casing having a space therein; a stator provided in the casing, the stator comprising a coil along which current flows; a vibrator provided in the casing and facing the stator, the vibrator being horizontally moved by electromagnetic force; an elastic body fixed at a first end thereof to the casing and fixed at a second end thereof to the vibrator; and a residual vibration reducer provided between the vibrator and the casing, the residual vibration reducer absorbing vibration of the vibrator.

The residual vibration reducer may be disposed in a direction corresponding to a direction in which the vibrator vibrates. The residual vibration reducer may absorb vibration of the vibrator in two stages.

The residual vibration reducer may include a fixed part which is fixed to the casing or the vibrator, and a movable part which extends from the fixed part and moves in response to the movement of the vibrator.

The fixed part may be fixed to the vibrator, and the movable part may be bent from the fixed part and extend therefrom without being fixed to the casing or vibrator.

The fixed part may be fixed to the casing, and the movable part may extend from the fixed part without being fixed to the casing or vibrator.

The residual vibration reducer may be disposed on a side surface or a corner of the vibrator that corresponds to a direction opposite to the vibration direction of the vibrator, thus absorbing the vibration of the vibrator.

The residual vibration reducer may include a fixed part which is fixed to the casing, and a movable part which perpendicularly extends from the fixed part and moves in response to the movement of the vibrator.

The movable part may make contact with the weight of the vibrator.

In another aspect, the present invention provides a vibration generator, including: a casing having a space therein; a stator provided in the casing, the stator comprising a coil along which current flows; a vibrator provided in the casing and facing the stator, the vibrator being horizontally moved by electromagnetic force; an elastic body fixed at a first end thereof to the casing and fixed at a second end thereof to the vibrator; and a coil stopper limiting movement of the coil and protecting the coil from the vibrator.

Furthermore, the coil stopper may enclose the periphery of the coil.

The coil stopper may be open on one surface thereof.

The coil stopper may be disposed in a central hollow space of the coil and protrude higher than the coil in the direction facing the vibrator.

The coil stopper may enclose the periphery of the coil, and one side thereof may protrude towards the side surface of the vibrator.

Further, the coil stopper may further include a protrusion for protecting the side surface of the vibrator from the casing.

In addition, the coil stopper may be open on one surface thereof.

The weight of the vibrator may have a protrusion protruding towards a surface of the coil that faces the weight.

A magnetic fluid may be applied to the magnet to prevent interference which is caused when the vibrator vibrates.

In a further aspect, the present invention provides a vibration generator, including: a casing having a space therein; a stator provided in the casing, the stator comprising a coil along which current flows; a vibrator provided in the casing and facing the stator, the vibrator being horizontally moved by electromagnetic force; an elastic body fixed at a first end thereof to the casing and fixed at a second end thereof to the vibrator; and a spacer for spacing a portion of the first end of the elastic body, fixed to the casing, apart from an inner surface of the casing.

The spacer may comprise a protruding part provided on an inner surface of the casing so that a portion of the first end of the elastic body is spaced apart from the inner surface of the casing by the protruding part.

The spacer may comprise a plurality of embossments provided on the first end of the elastic body so that a portion of the first end of the elastic body is spaced apart from the inner surface of the casing by the embossments.

The spacer may comprise a bending part formed by bending a portion of the first end of the elastic body so that a non-bent portion of the elastic body, other than the bent portion of the first end, is spaced apart from the inner surface of the casing by the bending part.

The spacer may comprise a metal plate disposed between the elastic body and the casing so that a portion of the first end of the elastic body is spaced apart from the inner surface of the casing by the metal plate.

The elastic body may be fixed to the spacer of the casing by welding the junction therebetween.

In a still another aspect, the present invention provides a vibration generator, including: a casing having a space therein; a stator provided in the casing, the stator provided with a coil along which current flows; a vibrator provided in the casing and facing the stator, the vibrator being horizontally moved by electromagnetic force; and an elastic body fixed at a first end thereof to the casing and fixed at a second end thereof to the vibrator, wherein the vibrator comprises a weight having an inner space therein, and a first magnet, yoke plate and a second magnet that are installed in the inner space of the weight.

The yoke plate may have a receiving depression for receiving the second magnet. The second magnet may be installed in the receiving depression.

The second magnet may comprise two second magnets. The two second magnets may be respectively disposed in medial portions of the opposite surface of the second-magnet-receiving depression.

The second magnet may comprise four second magnets. The two second magnets may be respectively disposed in four corners of the second-magnet-receiving depression.

The second magnet may comprise two second magnets. The two second magnets may be respectively disposed in two diagonally opposing corners of the second-magnet-receiving depression.

The second magnet may comprise a planar plate having the same size as that of the first magnet.

The second magnet may comprise a rubber magnet having elasticity.

The second magnet may comprise a sintered magnet. The second magnet may comprise a magnet, one surface of which is four-pole magnetized.

Further, a magnetic fluid may be applied to the upper surface of the second magnet that faces the inner surface of the casing.

In yet another aspect, the present invention provides a vibration generator, including: a casing having a space therein; a stator provided in the casing, the stator comprising a coil along which current flows; a vibrator provided in the casing and facing the stator, the vibrator being horizontally moved by electromagnetic force; and an elastic body fixed at a first end thereof to the casing and fixed at a second end thereof to the vibrator, wherein the second end of the elastic body is fixed to the weight of the vibrator, and the first end of the elastic body is bent by a predetermined length and a surface of a overlapping portion of the bent first end is fixed to an inner surface of the casing.

The elastic body may be partitioned into three surfaces which include a first end surface formed on the first end, a second end surface formed on the second end and a connection surface connecting the first end surface to the second end surface. The elastic body may be configured such that the connection surface does not make contact with the weight.

In yet another aspect, the present invention provides a method of manufacturing a vibration generator including: a casing having a space therein; a vibrator installed in the casing and provided with a weight; an elastic body fixed in the casing; a magnetic field generating unit comprising a magnet for providing electromagnetic force to horizontally vibrate the vibrator, a coil spaced apart from the magnet by a predetermined distance, and an FPCB; and a cover assembled with the casing to cover an open surface of the casing, the method including: a first assembly process comprising disposing the magnet and the yoke plate in a magnet receiving depression formed in the weight to form the vibrator, fixing the vibrator to the elastic body, and fixing the elastic body in the casing, thus forming a first assembly; a second assembly process separately conducted from the first assembly process, the second assembly process comprising installing the FPCB and the coil in the cover, and installing a coil stopper to protect the coil from the vibrator, thus forming a second assembly; and a third assembly process assembling the first assembly manufactured through the first assembly process with the second assembly manufactured through the second assembly process.

The first assembly process, to prevent the elastic body from being deformed, may further include attaching a main rubber to a surface of the weight that is not enclosed by the elastic body, and attaching a side rubber to a surface of the weight that is opposite to the surface thereof to which the main rubber.

The second assembly process may further include attaching a guide rubber to an inner surface of the cover to prevent the elastic body from being deformed.

### BRIEF DESCRIPTION OF THE DRAWINGS

The above and other objects, features and advantages of the present invention will be more clearly understood from the following detailed description taken in conjunction with the accompanying drawings, in which:

FIG. 1 is an exploded perspective view illustrating a vibration generator according to an embodiment of the present invention;

FIG. 2 is a perspective view showing the internal construction of an assembled vibration generator of FIG. 1;

FIGS. 3A through 3C are views illustrating the operation of a residual vibration reducer of the vibration generator according to the present invention;

FIG. 4 is a view illustrating a second embodiment of the residual vibration reducer installed in the vibration generator according to the present invention;

FIG. 5 is a view illustrating a third embodiment of the residual vibration reducer installed in the vibration generator according to the present invention;

FIG. 6 is a view illustrating a fourth embodiment of the residual vibration reducer installed in the vibration generator according to the present invention;

FIG. 7 is an exploded perspective view of a second embodiment of a coil stopper of the vibration generator according to the present invention;

FIG. 8 is a view illustrating the second embodiment of the coil stopper of the vibration generator according to the present invention;

FIG. 9 is a view illustrating a third embodiment of the coil stopper of the vibration generator according to the present invention;

FIG. 10 is a view illustrating a fourth embodiment of the coil stopper of the vibration generator according to the present invention;

FIGS. 11A and 11B are views illustrating a first embodiment of a spacer of the vibration generator according to the present invention;

FIGS. 12A and 12B are views illustrating a second embodiment of a spacer of the vibration generator according to the present invention;

FIGS. 13A and 13B are views illustrating a third embodiment of a spacer of the vibration generator according to the present invention;

FIGS. 14A and 14B are views illustrating a fourth embodiment of a spacer of the vibration generator according to the present invention;

FIGS. 15A through 15C are views illustrating several embodiments of the vibration generator according to the present invention;

FIG. 16 is a sectional view of the vibration generator to illustrate application of a magnetic fluid according to the present invention;

FIG. 17 is an exploded perspective view illustrating another embodiment of an elastic body of the vibration generator according to the present invention;

FIG. 18 is a plan view showing an assembled state of FIG. 17;

FIG. 19 is a view showing a main rubber and a side rubber which are respectively attached to opposite side surfaces of the vibrator of the vibration generator according to the present invention; and

FIG. 20 is a view showing a guide rubber attached to a cover of the vibration generator according to the present invention.

### DESCRIPTION OF THE PREFERRED EMBODIMENTS

Hereinafter, a vibration generator according to the present invention will be described in detail with reference to the attached drawings.

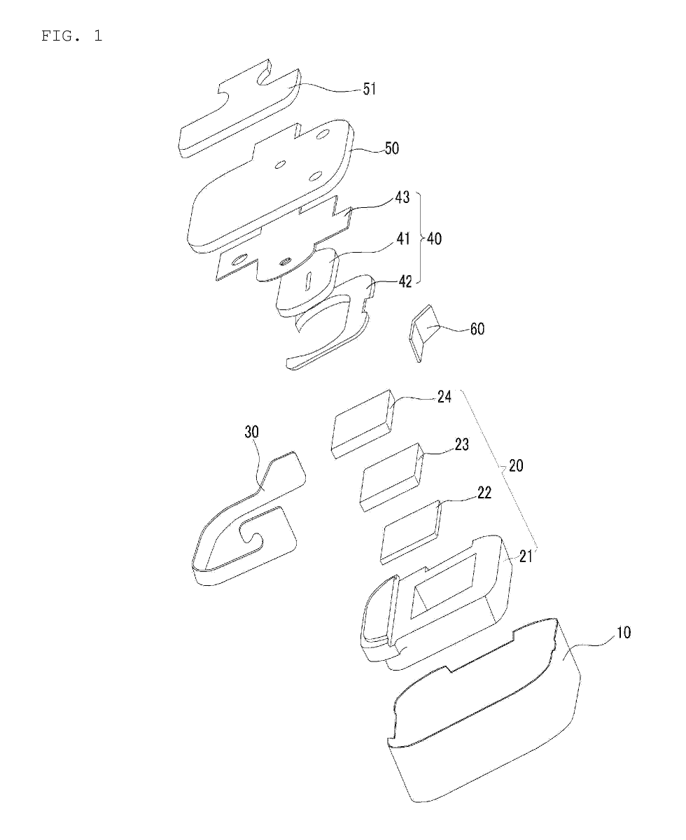

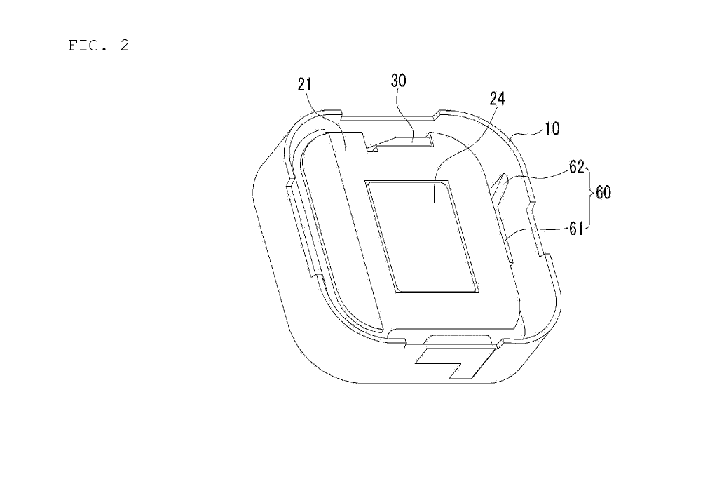

As shown in FIGS. 1 and 2, the vibration generator according to the present invention includes a casing 10 which is open on one surface thereof and has a space therein, a stator which is provided in the casing 10 and provided with a coil 41 along which current flows, a vibrator 20 which is provided in the casing 10 and is horizontally moved by electromagnetic force against the stator 40, an elastic body 30 which is fixed at a first end thereof to the casing 10 and fixed at a second end thereof to the vibrator 20, a cover 50 which covers the open surface of the casing 10, a rubber body 51 which is installed on an outer surface of the cover 50 to protect elements from external impact, and a residual vibration reducer 60 which is provided between the vibrator 20 and the casing 10 and absorbs vibration of the vibration 20 in two stages.

The casing 10 is made of a nonmagnetic electric conductor and has a rectangular container shape configured such that one surface thereof is open, the other surfaces thereof are closed to define a space therein, and four sides of the closed surface extend perpendicular to the closed surface and forms four sidewalls.

The stator 40 includes a FPCB (flexible printed circuit board) 43 which applies an external electric signal to the coil 41, the coil 41 which receives an external electric signal from the FPCB 43 and generates a magnetic field, and a coil stopper 42 which limits the movement of the coil 41. The stator 40 is disposed at a position spaced apart from the vibrator 20 by a predetermined distance. The coil 41 forms a hollow structure which has an internal space in a central portion thereof and is configured in a circular or rectangular shape. Preferably, the coil 14 comprises a wound self bonding wire. A core may be installed in the internal space of the hollow structure formed by the coil 41 or may be omitted. The core is preferably made of metal that has magnetic permeability.

As shown in FIG. 1, the vibrator 20 includes a weight 21, and a first magnet 22, a yoke plate 23 and a second magnet 24 which are installed in an internal space of the weight 21.

The weight 21 is made of metal having a comparatively high specific gravity and has an internal space which is a through hole. The first magnet 22, the yoke plate 23 and the second magnet 24 are successively installed in the internal space of the weight 21.

The yoke plate 23 is disposed between the first magnet 22 and the second magnet 24 and functions as a rail through which lines of magnetic force generated from N poles of the first and second magnets 22 and 24 enters S poles of them. The yoke plate 23 is made of magnetic material, wherein the higher the magnetic permeability of the magnetic material, the better.

The elastic body 30 has a “U” shape, and the first end thereof is fixed to the casing 10. The elastic body 30 functions to make the vibrator 20 horizontally vibrate using a resonant phenomenon induced by means of applying the same frequency as that of the natural frequency of the vibrator 20 thereto.

The FPCB 43 is elastically connected to the coil 41 and applies an external electric signal to the coil 41 to form a magnetic field around the coil 41. Although, in FIG. 1, the FPCB 43 is illustrated as being installed on an inner surface of the cover 50 that is coupled to the open surface of the casing 10, the present invention is not limited to the embodiment of FIG. 1 and can be modified into any shape or construction, so long as it can apply an external electric signal to the coil 41 to form a magnetic field around the coil 41.

The residual vibration reducer 60 is installed between the vibrator 20 and the casing 10 on a surface of the vibrator 20 that corresponds to the direction in which the vibrator 20 moves. The residual vibration reducer 60 is configured to absorb vibration of the vibrator 20 in two stages.

As shown in FIG. 2, in a first embodiment, the residual vibration reducer 60 includes a fixed part 61 which is fixed to a surface of the vibrator 20 that corresponds to the direction vibrator 20 moves, and a movable part 62 which extends from the fixed part 61 and is moved by movement of the vibrator 20. The fixed part 61 is fixed to the surface of the vibrator 20 that corresponds to the movement direction of the vibrator 20. The movable part 62 is bent from the fixed part 61 and extends a predetermined length. The movable part 62 is neither fixed to the casing 10 nor the vibrator 20.

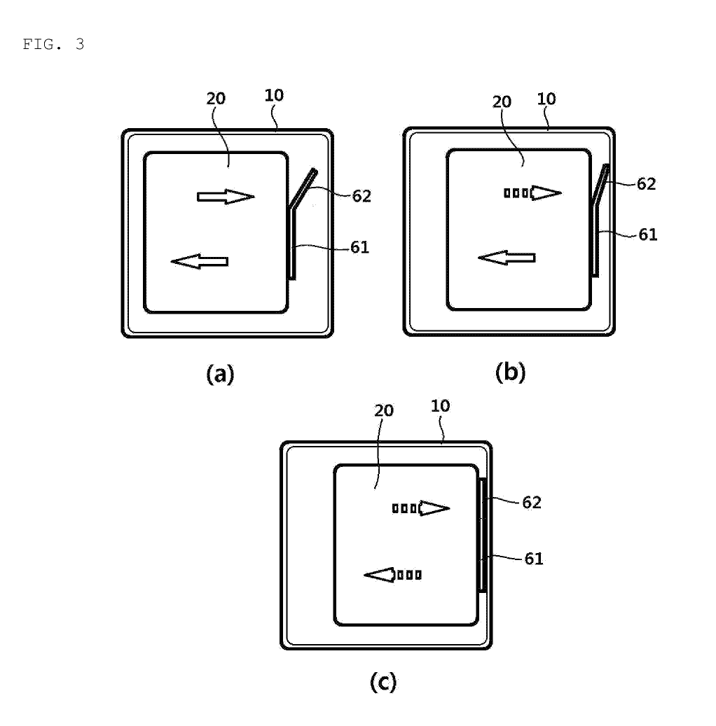

The operation of the first embodiment of the residual vibration reducer 60 will be explained with reference to FIGS. 3A through 3 C.

FIG. 3A illustrates an initial state of vibration of the vibrator 20 in the casing 10. FIG. 3B illustrates a process in which the vibrator 20 is moved towards the right sidewall of the casing 10. FIG. 3C illustrates a state in which the vibrator 20 further moves and reaches the inner surface of the right sidewall of the casing 10.

As shown in FIG. 3B, during the process in which the vibrator 20 is moved towards the right sidewall of the casing 10, the movable part 62 of the residual vibration reducer 60 comes into contact with the inner surface of the right sidewall of the casing 10 and primarily absorbs vibration of the vibrator 20.

Thereafter, as shown in FIG. 3C, when the vibrator 20 further moves and reaches the inner surface of the right sidewall of the casing 10, the movable part 62 and the fixed part 61 of the residual vibration reducer 60 become linear and secondarily absorb impact applied from the vibrator 20 to the casing 10.

Preferably, the residual vibration reducer 60 is made of rubber or the like to more effectively absorb the vibration of the vibrator 20.

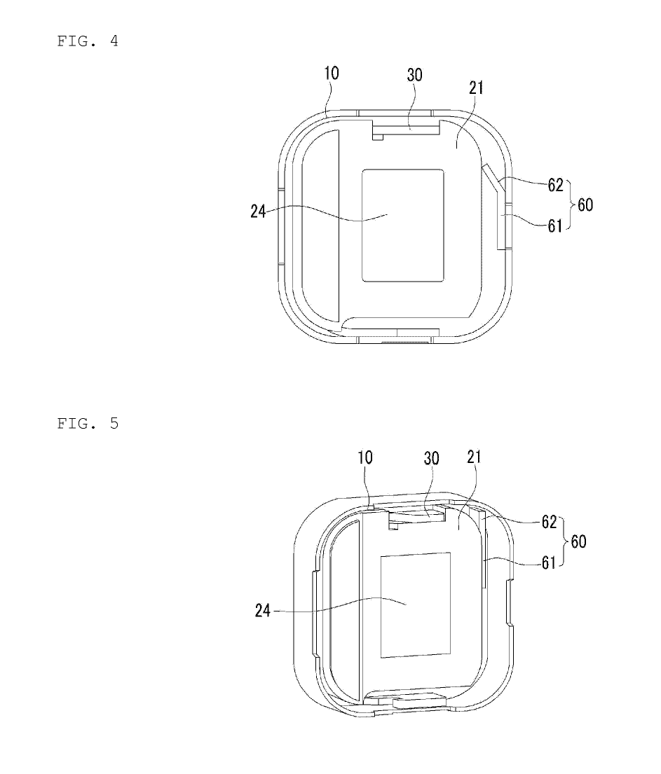

In a second embodiment of the residual vibration reducer 60, as shown in FIG. 4, the residual vibration reducer 60 is configured such that the first part 61 is fixed to the casing 10, and the movable part 62 extends from the fixed part 61 and is neither fixed to the casing 10 nor the vibrator 20. In this embodiment, when the vibrator 20 is moved towards the right sidewall of the casing 10, the movable part 62 of the residual vibration reducer 60 comes into contact with a right side surface of the vibrator 20 and primarily absorbs vibration of the vibrator 20. When the vibrator 20 further moves and reaches the inner surface of the right sidewall of the casing 10, the movable part 62 and the fixed part 61 of the residual vibration reducer 60 become a linear line and secondarily absorb impact applied from the vibrator 20 to the casing 10.

In a third embodiment of the residual vibration reducer 60, as shown in FIG. 5, the fixed part 61 of the residual vibration reducer 60 is fixed to the surface of the vibrator 20 that corresponds to the movement direction of the vibrator 20. The movable part 62 linearly extends from the fixed part 61 without being fixed to the vibrator 20. In this case, when the movable part 62 comes into contact with the corresponding corner of the casing 10, the residual vibration reducer 60 primarily absorbs vibration of the vibrator 20. When the vibrator 20 further moves and reaches the inner surface of the right sidewall of the casing 10, the movable part 62 and the fixed part 61 of the residual vibration reducer 60 secondarily absorb vibrational impact applied from the vibrator 20 to the casing 10.

As such, the residual vibration reducer 60 is installed between the vibrator 20 and the casing 10 at a position corresponding to the movement direction of the vibrator 20 and thus forms the structure which absorbs vibration of the vibrator 20 in two stages.

That is, the movable part 62 of the residual vibration reducer 60 primarily reduces elastic force generated from the vibrator 20 in the movement direction of the vibrator 20, thus absorbing vibration of the vibrator 20. The fixed part 61 of the residual vibration reducer 60 secondarily reduces the elastic force so that the vibrator 20 can be stopped in a short time. Thereby, the residual vibration reducer 60 can reduce residual vibration of the vibrator 20 that is vibration generated by the elastic force after the electromagnetic force is turned off, thus stopping the vibration 20 in a short time. In other words, a residual vibration duration for which residual vibration occurs can be reduced. Here, vibration force reduction is not caused.

Furthermore, because the residual vibration reducer 60 is installed on the vibrator 20 or on the surface of the casing 10 that faces the vibrator 20 with respect to the movement direction of the vibrator 20, the movable part 62 and the fixed part 61 function to reduce contact noise between the casing 10 and the vibrator 20 while coming into contact with the vibrator 20 or the surface of the casing 10 that faces the vibrator 20 with respect to the movement direction of the vibrator 20.

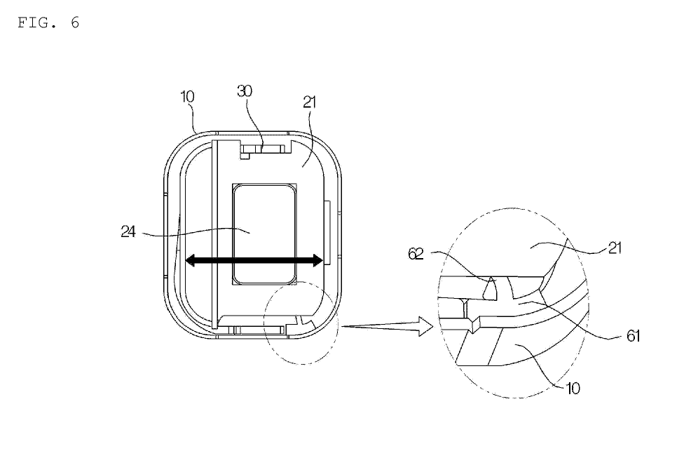

In a fourth embodiment of the residual vibration reducer 60, as shown in FIG. 6, the residual vibration reducer 60 for absorbing vibration of the vibrator 20 is disposed on a sidewall or corner of the casing 10 that faces the direction perpendicular to the movement direction of the vibrator 20.

The residual vibration reducer 60 has a “T” shape and includes a fixed part 61 which is fixed on the casing 10, and a movable part 62 which extends perpendicular to the fixed part 61 and moves in response to the movement of the vibrator 20. An end of the movable part 62 makes contact with the weight 12 of the vibrator 20 to reduce vibration of the vibrator 20.

Next, the coil stopper 42, which limits movement of the coil 41 that is one of the elements of the stator 40 of the vibration generator and protects the coil 41 from the vibrator 20, will be described below.

The coil stopper 42 functions to limit the movement of the coil 41 to prevent the coil 41 from being damaged when the coil 41 of the stator 40 is moved by movement of the stator 40 in response to displacement of the vibrator 20 when external impact, e.g., free fall shock or the like, is applied to the vibration generator.

It is preferable that the coil stopper 42 for protecting the coil 41 protrude higher than the coil 41. The coil stopper 42 is formed by plastic injection molding and fixed to the coil 41 by means of a thermosetting adhesive applied to the inner or outer surface of the coil 41.

In a first embodiment of the coil stopper 42, as shown in FIG. 1, the coil stopper 42 is configured to enclose the periphery of the coil 41 and be open on one surface of the periphery of the coil 41.

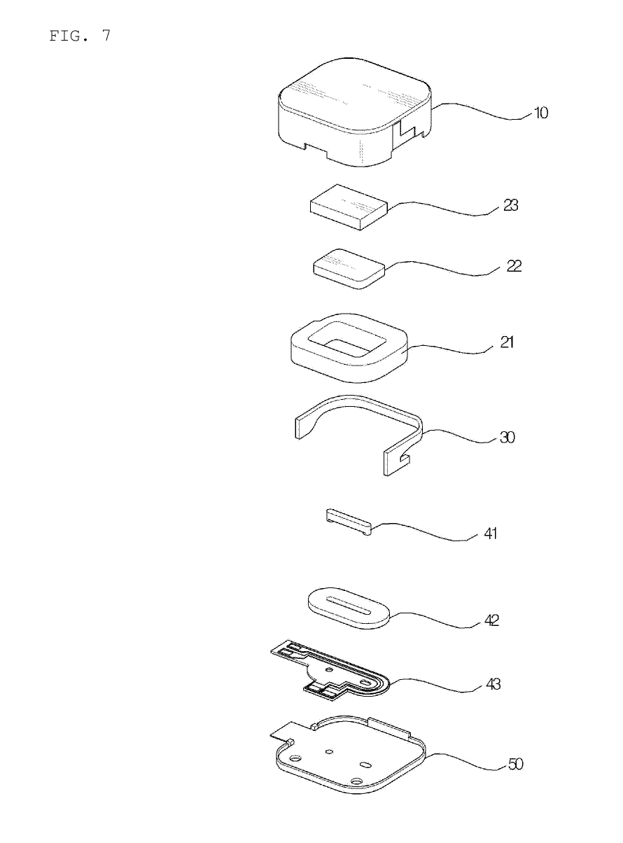

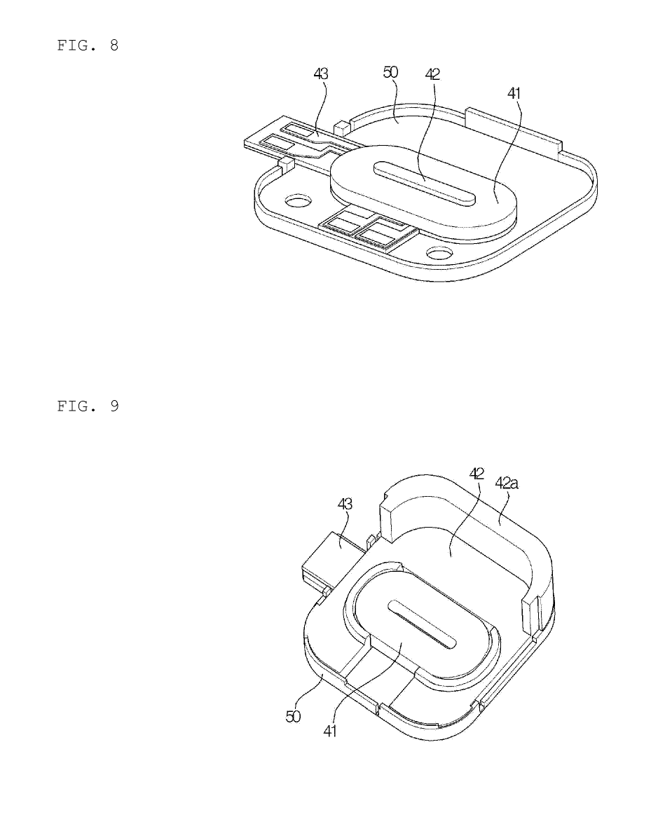

In a second embodiment of the coil stopper 42, as shown in FIGS. 7 and 8, the coil stopper 42 is installed in the central hollow space of the coil 41 and protrudes higher than the coil 41 in the direction facing the vibrator 20.

In a third embodiment of the coil stopper 42, as shown in FIG. 9, the coil stopper 42 encloses the periphery of the coil 42 and has at one side thereof a protruding part 42a that faces a side surface of the vibrator 20.

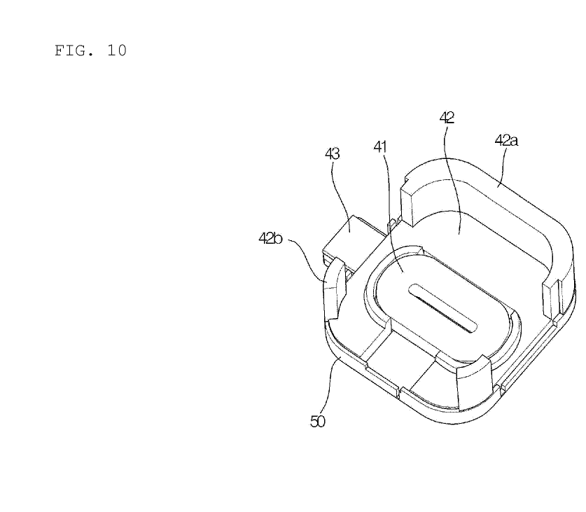

In a fourth embodiment of the coil stopper 42, as shown in FIG. 10, the coil stopper 42 has at one side thereof a protrusion part 42a that faces a side surface of the vibrator 20 in the same manner as that of the third embodiment and has at other sides thereof protrusions 42b for protecting the corresponding side surfaces of the vibrator 20 from the casing.

The portion of the weight 21 that does not correspond to the coil stopper 42 may be inclined to one side because of a gap formed therebetween. Therefore, to maintain the balance, the weight 21 of the vibrator 20 may have a protrusion (not shown) on a surface thereof that faces the coil 41.

Furthermore, in the vibrator 20, a magnetic fluid may be applied to the surface of the magnet 22 or 24 that is received in the magnet receiving depression of the weight to prevent the coil from snapping because of interference of the vibrator 20 or/and prevent the magnet 22 or 24 from colliding with the inner surface of the corresponding sidewall of the casing 10.

Next, in the vibration generator according to the present invention, a spacer for spacing a portion of a first end of the elastic body 30 that is fixed to the casing 10 apart from the inner surface of the corresponding sidewall of the casing 10 will be described below.

The elastic body 30 includes the spacer for preventing the elastic body 30 from touching the casing 10, so that an increase in resonant frequency and performance degradation can be prevented.

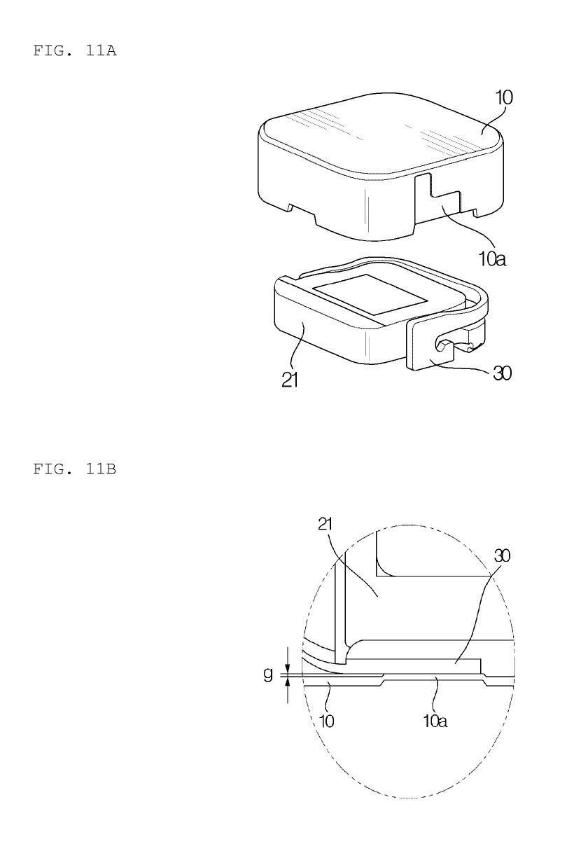

In a first embodiment of the spacer, as shown in FIGS. 11A and 11B, the spacer comprises a protruding part 10a which is provided on the inner surface of the casing 10 so that a portion of the first end of the elastic body 30 is spaced apart from the inner surface of the casing 10 by the protruding part 10a. That is, as shown in FIG. 11B, the protruding part 10a protrudes from a portion of the inner surface of the casing 10, and a portion of the first end of the elastic body 30 makes contact with the protruding part 10a, but the other portion of the first end of the elastic body 30 is spaced apart from the inner surface of the casing 10 by a predetermined gap g.

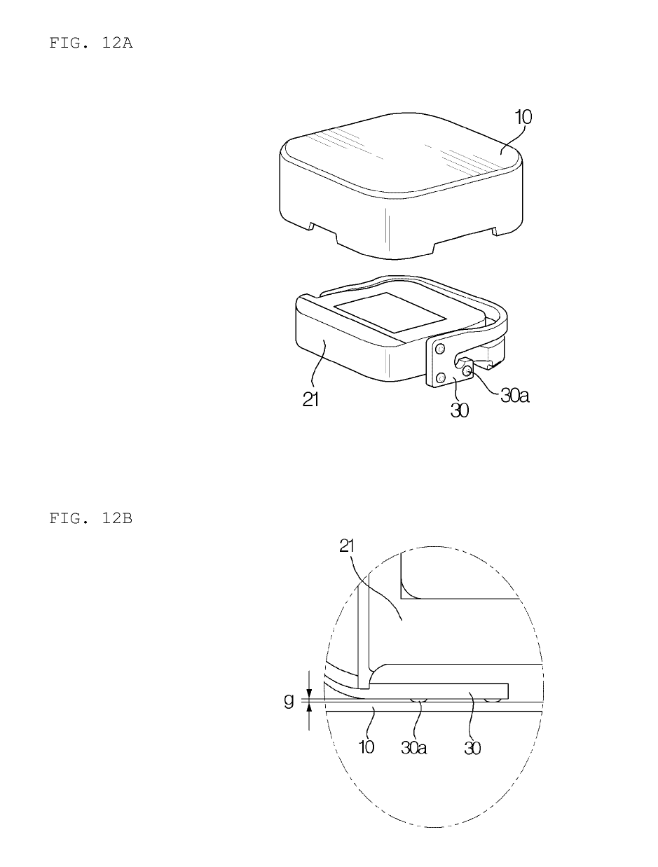

In a second embodiment of the spacer, as shown in FIGS. 12A and 12B, a plurality of embossments 30a are provided on the first end of the elastic body 30 so that a portion of the first end of the elastic body 30 is spaced apart from the inner surface of the casing 10 by the embossments 30a by a predetermined gap g.

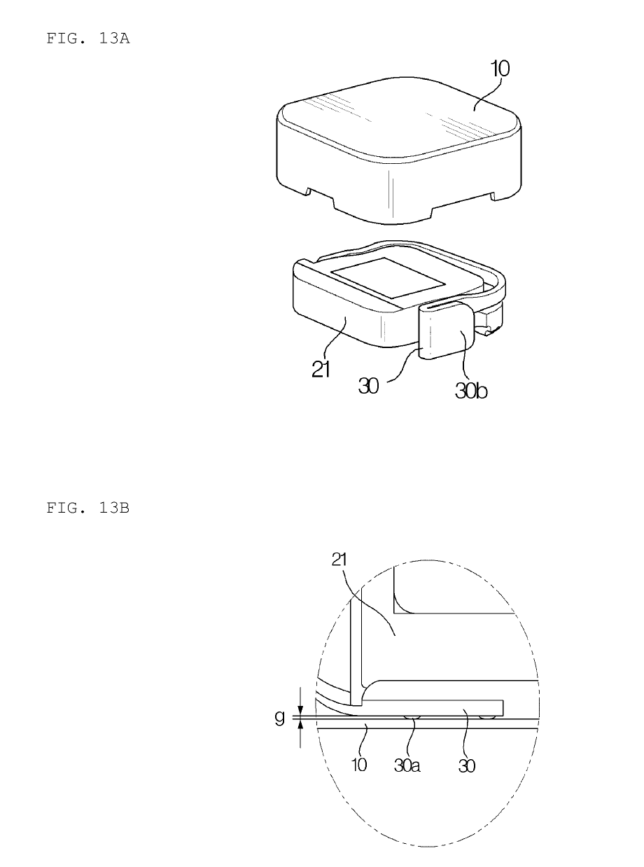

In a third embodiment of the spacer, as shown in FIGS. 13A and 13B, a bending part 30b is formed by bending a portion of the first end of the elastic body 30 so that the other portion of the first end of the elastic body 30 that is not bent is spaced apart from the inner surface of the casing 10 by the bending part 30b by a predetermined gap g.

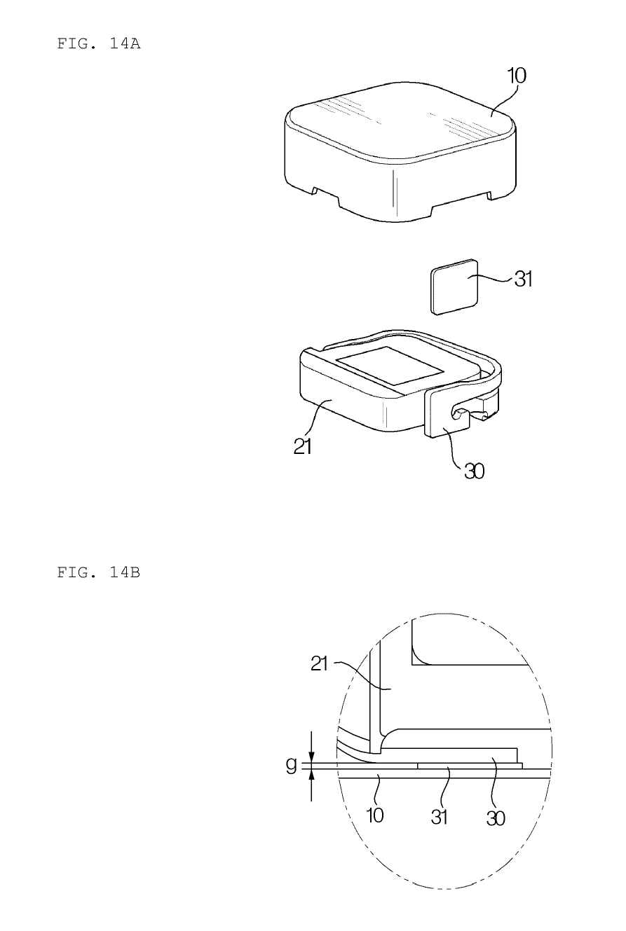

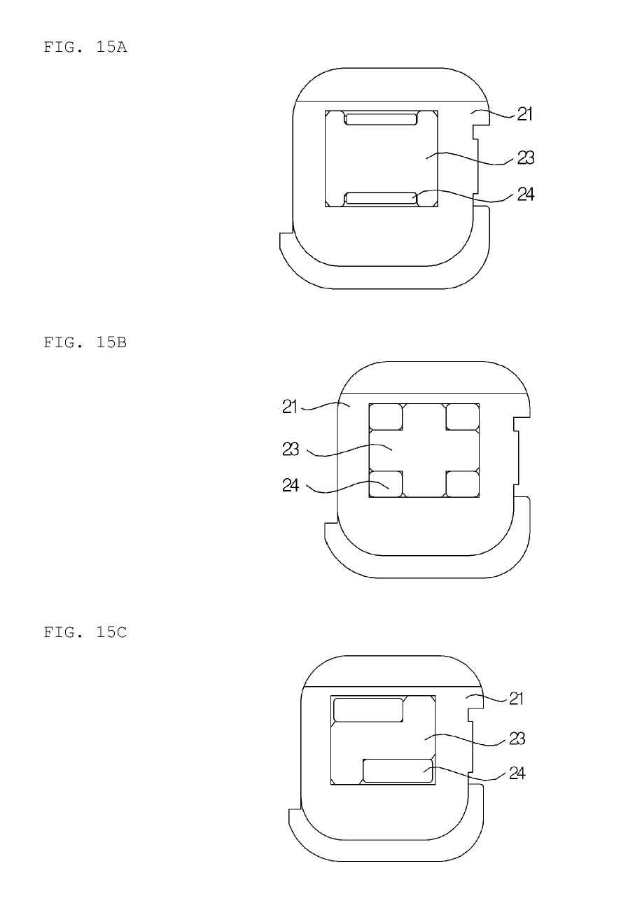

In a fourth embodiment of the spacer, as shown in FIGS. 14A and 14B, a metal plate 31 is interposed between the elastic body 30 and the casing 10 so that a portion of the first end of the elastic body 30 can be spaced apart from the inner surface of the casing 10 by the metal plate 31 by a predetermined gap g.

In the above-mentioned embodiments of the spacer, the elastic body 30 may be fixed to the spacer of the casing 10 by welding the junction therebetween.

Next, the vibrator 20 of the vibration generator according to the present invention which uses a size-reduced main magnet (22, first magnet) to reduce the cost for providing the magnet will be described below.

As shown in FIGS. 1, 15A through 15C, to reduce the cost for providing the magnet, the vibrator 20 includes the weight 21, the first magnet 22 which is installed in the internal receiving space of the weight 21, the yoke plate 23 and the second magnet 24.

In a first embodiment of the vibrator 20, as shown in FIG. 1, the first magnet 22, the yoke plate 23 and the second magnet 24 which have the same planar shape and the same size are disposed in the receiving depression of the weight and successively stacked on top of one another.

Alternatively, as shown in FIGS. 15A through 15C, the vibrator 20 may be configured such that the yoke plate 23 has a receiving space for the second magnet 24 and the second magnet 24 is installed in the receiving space.

FIG. 15A illustrates an example in which two second magnets 24 are provided and second magnet receiving spaces are respectively formed in the medial portions of opposite side surfaces of the yoke plate 23 so that the two second magnets 24 are installed in the opposite side surfaces of the yoke plate 23.

FIG. 15B illustrates an example in which four second magnets 24 are provided and second magnet receiving spaces are respectively formed in the four corners of the yoke plate 23 so that the four second magnets 24 are installed in the four corners of the yoke plate 23.

FIG. 15C illustrates an example in which two second magnets 24 are provided and second magnet receiving spaces are respectively formed in two diagonally opposing corners of the yoke plate 23 so that the two second magnets 24 are respectively installed in the two diagonally opposing corners of the yoke plate 23.

In each embodiment, the second magnet 24 may comprise a rubber magnet that has a predetermined elasticity, or a sintered magnet.

Furthermore, in each embodiment, the second magnet 24 comprises a magnet, one surface of which is four-pole magnetized.

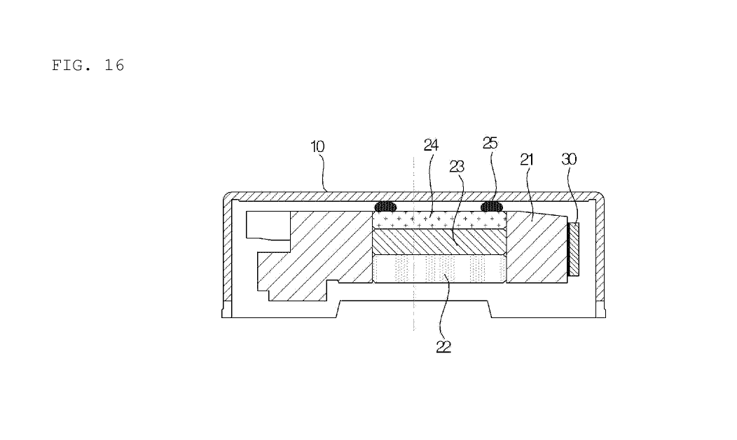

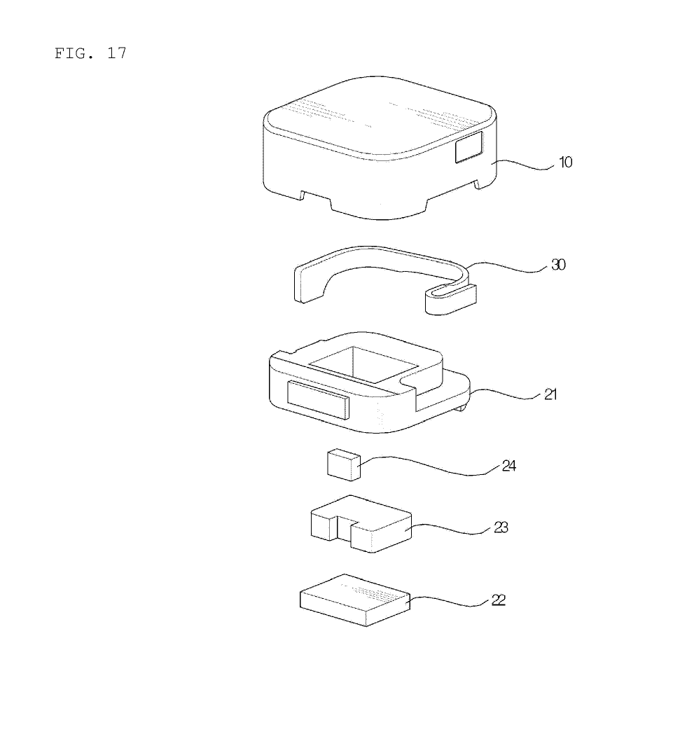

As shown in FIG. 16, a magnetic fluid 25 is applied to an upper surface of the second magnet 24. The magnetic fluid 25 functions as a damper to absorb contact impact between the vibrator 20 and the corresponding inner surface of the casing 10. By virtue of the magnetic fluid 25, contact between the inner surface of the casing 10 and the vibrator 20 can be more effectively prevented from being caused when vertical vibration occurs.

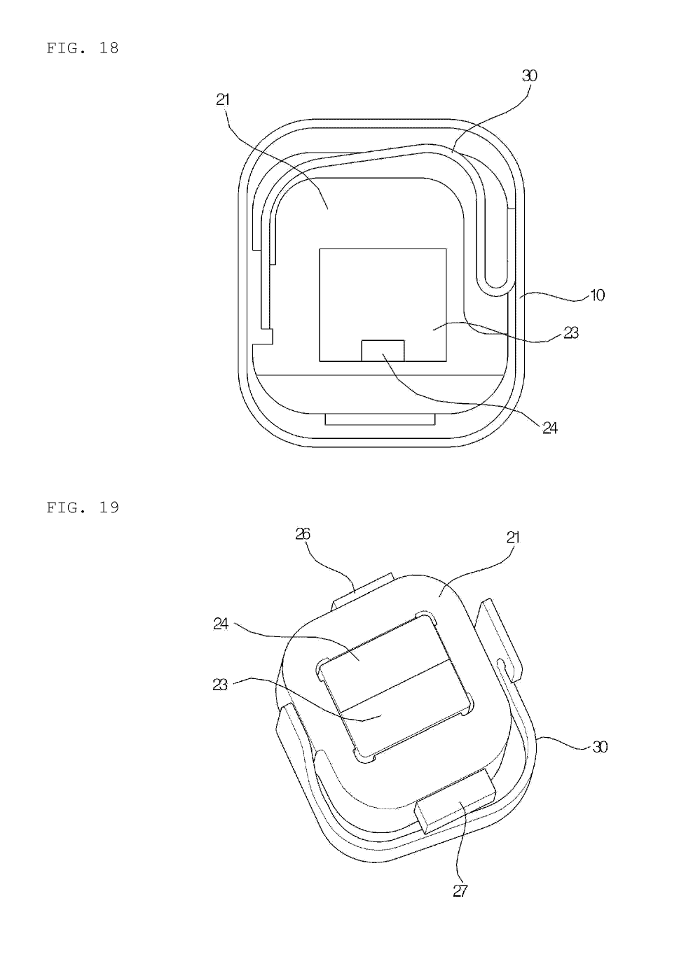

Next, the structure of the elastic body 30, which is able to have an increased length and achieve slimness to overcome spatial constraints and provide high vibration, will be described with reference to FIGS. 17 and 18.

As shown in FIGS. 17 and 18, the first end of the elastic body 30 is fixed to the weight 21 of the vibrator 20. The second end of the elastic body 30 is bent by a predetermined length, and the surface of the overlapping portion of the second end thereof is fixed to the inner surface of the casing 10. Overall, the elastic body 30 forms an approximate S shape.

Unlike the typical elastic body shown in FIG. 1, etc., because a modification of the elastic body shown in FIGS. 17 and 18 has an approximate S shape, the elastic body 30 is configured to be comparatively long and slim, thus reducing spatial constraints, and providing high vibration.

Furthermore, the elastic body 30 is partitioned into three surfaces which include a first end surface formed on the first end, a second end surface formed on the second end and a connection surface connecting the first end surface to the second end surface. The elastic body 30 is configured such that the connection surface does not make contact with the weight 21. That is, as shown in FIG. 18, the first end surface formed on the first end is brought into contact with the weight 21 and is fixed thereto. The surface of the overlapping portion formed by bending a predetermined length of the second end is brought into contact with the inner surface of the casing 10 and is fixed thereto. However, the connection surface makes no contact with the weight 21.

Meanwhile, a vibration generator manufacturing method according to the present invention relates to a method for manufacturing a vibration generator that includes: a casing which has a space therein; a vibrator 20 which is provided in the casing 10 and has a weight 21; an elastic body 30 which is fixed in the casing 10; a magnetic field generating unit which includes magnets 22 and 24 for providing electromagnetic force to horizontally vibrate the vibrator 20, a coil 41 spaced apart from the magnets 22 and 24 by a predetermined distance, and an FPCB 43; and a cover 50 which is assembled with the casing 10 to cover the open surface of the casing 10.

With regard to the process of manufacturing the vibration generator having the above-mentioned construction, the vibration generator manufacturing method according to the present invention has several separate assembly processes, including a first assembly process through which a first assembly is completed, a second assembly process through which a second assembly is completed, and a third assembly process during which the first assembly manufactured through the first assembly process is assembled with the second assembly manufactured through the second assembly process.

The first assembly process includes disposing the magnets 22 and 24 and the yoke plate 23 in the magnet receiving depression formed in the weight 21 to form the vibrator 20, fixing the vibrator 20 to the elastic body 30, and fixing the elastic body 30 in the casing 10, thus forming the first assembly. The second assembly process includes installing the FPCB 43 and the coil 41 in the cover 50, and installing a coil stopper 42 to protect the coil 41 from the vibrator 20, thus forming the second assembly.

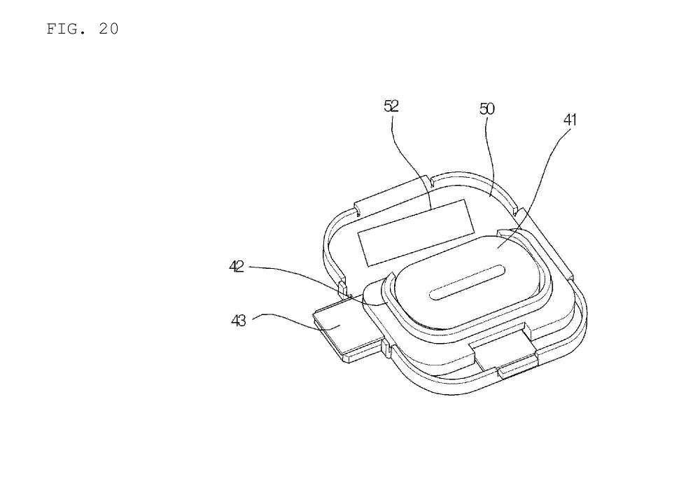

To prevent the elastic body 30 from being deformed, the first assembly process, as shown in FIG. 19, may further include attaching a main rubber 26 to a surface of the weight 21 that is not enclosed by the elastic body 30, and attaching a side rubber 27 to a surface of the weight 21 that is opposite to the surface to which the main rubber is attached. The reason for this is to prevent the elastic body 30 from being deformed by contact impact between the weight 21 and the casing 10 in the case where space around the weight 21 and the elastic body 30 is comparatively large.

As shown in FIG. 20, the second assembly process may further include attaching a guide rubber 52 to the inner surface of the cover 50 to prevent the elastic body 30 from being deformed. The reason for this is to minimize empty space between the weight 21 and the cover 50 and thus prevent the elastic body 30 from being deformed.

As described above, the present invention a vibration generator which includes a casing having a space therein, a stator provided in the casing and having a coil along which current flows, a vibrator provided in the casing at a position facing the stator such that the vibrator can be horizontally moved by electromagnetic force, and an elastic body fixed at a first end thereof to the casing and fixed at a second end thereof to the vibrator. A residual vibration reducer is installed between the vibrator and the casing to absorb vibration of the vibrator in two stages, whereby when the operation of the vibration generator is interrupted, the movement of the vibrator can be rapidly stopped, and contact noise caused when the vibrator is vibrating can be reduced.

Furthermore, a coil stopper is provided to limit the movement of the coil and protect the coil from the vibrator, whereby when external impact, e.g., free fall shock or the like, is applied to the vibration generator, the stator (coil) can be prevented from being undesirably moved or damaged due to movement displacement of the vibrator.

In addition, a spacer for spacing a portion of the first end of the elastic body, fixed to the casing, apart from an inner surface of the casing is provided so that the elastic body is prevented from making contact with the casing, thereby enhancing resonant frequency, and preventing performance deterioration.

The vibrator includes a weight having an inner space therein, and a first magnet, yoke plate and a second magnet that are installed in the inner space of the weight, whereby the size of the main magnet (first magnet) can be reduced, thus making it possible to reduce the cost required to provide the magnet.

The second end of the elastic body is fixed to the weight of the vibrator, and the first end of the elastic body is bent by a predetermined length and a surface of a overlapping portion of the bent first end is fixed to an inner surface of the casing so that the elastic body has an approximate “S” shape, thus making it possible for the elastic body to be comparatively long and slim, thereby reducing spatial constraints, and providing strong vibration.

Furthermore, the vibration generator manufacturing method according to the present invention can enhance the efficiency of the assembly process thanks to a simple assembly structure of the elements, and make the coupling between the elements more reliable, thus enhancing the reliability of products and reducing the production cost.

Although the preferred embodiments of the present invention have been disclosed for illustrative purposes, those skilled in the art will appreciate that various modifications, additions and substitutions are possible, without departing from the scope and spirit of the invention as disclosed in the accompanying claims.

What is claimed is:

1. A vibration generator, comprising:
a casing having a space therein;
a stator provided in the casing, the stator comprising a coil along which current flows;
a vibrator provided in the casing and facing the stator, the vibrator being horizontally moved by electromagnetic force;
an elastic body fixed at a first end thereof to the casing and fixed at a second end thereof to the vibrator; and
a residual vibration reducer provided between the vibrator and the casing, the residual vibration reducer absorbing vibration of the vibrator.

2. A vibration generator, comprising:
a casing having a space therein;
a stator provided in the casing, the stator comprising a coil along which current flows;
a vibrator provided in the casing and facing the stator, the vibrator being horizontally moved by electromagnetic force;
an elastic body fixed at a first end thereof to the casing and fixed at a second end thereof to the vibrator; and
a coil stopper limiting movement of the coil and protecting the coil from the vibrator.

3. A vibration generator, comprising:
a casing having a space therein;
a stator provided in the casing, the stator comprising a coil along which current flows;
a vibrator provided in the casing and facing the stator, the vibrator being horizontally moved by electromagnetic force;
an elastic body fixed at a first end thereof to the casing and fixed at a second end thereof to the vibrator; and
a spacer for spacing a portion of the first end of the elastic body, fixed to the casing, apart from an inner surface of the casing.

4. A vibration generator, comprising:
a casing having a space therein;
a stator provided in the casing, the stator comprising a coil along which current flows;
a vibrator provided in the casing and facing the stator, the vibrator being horizontally moved by electromagnetic force; and
an elastic body fixed at a first end thereof to the casing and fixed at a second end thereof to the vibrator,
wherein the vibrator comprises a weight having an inner space therein, and a first magnet, yoke plate and a second magnet that are installed in the inner space of the weight.

5. A vibration generator, comprising:
a casing having a space therein;
a stator provided in the casing, the stator comprising a coil along which current flows;
a vibrator provided in the casing and facing the stator, the vibrator being horizontally moved by electromagnetic force; and
an elastic body fixed at a first end thereof to the casing and fixed at a second end thereof to the vibrator,
wherein the second end of the elastic body is fixed to the weight of the vibrator, and the first end of the elastic body is bent by a predetermined length and a surface of an overlapping portion of the bent first end is fixed to an inner surface of the casing.

6. A method of manufacturing a vibration generator comprising: a casing having a space therein; a vibrator installed in the casing and provided with a weight; an elastic body fixed in the casing; a magnetic field generating unit comprising a magnet for providing electromagnetic force to horizontally vibrate the vibrator, a coil spaced apart from the magnet by a predetermined distance, and an FPCB; and a cover assembled with the casing to cover an open surface of the casing, the method comprising:
a first assembly process comprising disposing the magnet and the yoke plate in a magnet receiving depression formed in the weight to form the vibrator, fixing the vibrator to the elastic body, and fixing the elastic body in the casing, thus forming a first assembly;
a second assembly process separately conducted from the first assembly process, the second assembly process comprising installing the FPCB and the coil in the cover, and installing a coil stopper to protect the coil from the vibrator, thus forming a second assembly; and
a third assembly process assembling the first assembly manufactured through the first assembly process with the second assembly manufactured through the second assembly process.
